(19) United States
(12) Patent Application Publication
(10) Pub. No.: US 2026/0284840 A1
(43) Pub. Date: Sep. 24, 2026

(54) TOOL SYSTEM, DETERMINATION PROCESSING METHOD, AND PROGRAM

(71) Applicant: Panasonic Corporation, Osaka (JP)

(72) Inventors: Atsushi NAKAMURA, Osaka (JP); Koichi HASHIMOTO, Shiga (JP)

(21) Appl. No.: 19/168,240

(22) PCT Filed: Mar. 4, 2024
(86) PCT No.: PCT/JP2024/007946

§ 371 Date: Sep. 23, 2025

(30) Foreign Application Priority Data
Mar. 30, 2023 (JP) 2023-056692

(51) Int. Cl. B25B 21/02

(52) U.S. Cl. CPC B25B 21/02

(57) ABSTRACT

A tool system includes a motor, a fastening unit, a control unit, a detection unit, a rotation stopper, and a condition determiner. The fastening unit includes: a hammer caused to rotate with motive power supplied from the motor; and an anvil arranged forward of the hammer in a rotational axis direction of the hammer to receive rotational impact from the hammer. The fastening unit fastens a fastening member by driving a tip tool in rotation. The control unit controls the motor. The detection unit detects a predetermined physical quantity in a state where the hammer is receiving the motive power. The rotation stopper prohibits the anvil from rotating. The condition determiner makes determination about the wear condition of the fastening unit based on the predetermined physical quantity detected by the detection unit in a state where the rotation stopper prohibits the anvil from rotating.

### TECHNICAL FIELD

The present disclosure generally relates to a tool system, a determination processing method, and a program, and more particularly relates to a tool system including a fastening unit for fastening a fastening member, a determination processing method, and a program.

### BACKGROUND ART

Patent Literature 1 discloses an electric tool system. The electric tool system includes an electric tool and a server system. The electric tool includes: an acquisition unit for acquiring physical quantity data detected while a motor is rotating; and a transmission unit for transmitting the physical quantity data and time information to the server system. The server system includes a state evaluation unit for evaluating the degree of condition of the electric tool based on the physical quantity data and time information thus received.

### CITATION LIST

### Patent Literature

Patent Literature 1: JP 2020-38580 A

### SUMMARY OF INVENTION

It cannot be said that the tool system of Patent Literature 1 evaluates (or determines) the condition of the tool under stabilized circumstances, considering the condition of load applied to the fastening unit including an anvil and other members, the difference in the type of the fastening member to be fastened by the fastening unit, and other factors. Consequently, a tool system of the type disclosed in Patent Literature 1 would cause a decline in the accuracy of determination made about the wear condition of the fastening unit.

In view of the foregoing background, it is therefore an object of the present disclosure to provide a tool system, a determination processing method, and a program, all of which contribute to determining the wear condition of the fastening unit more accurately.

A tool system according to an aspect of the present disclosure includes a motor, a fastening unit, a control unit, a detection unit, a rotation stopper, and a condition determiner. The fastening unit includes: a hammer caused to rotate with motive power supplied from the motor; and an anvil arranged forward of the hammer in a rotational axis direction of the hammer to receive rotational impact from the hammer. The fastening unit fastens a fastening member by driving a tip tool in rotation. The control unit controls the motor. The detection unit detects a predetermined physical quantity in a state where the hammer is receiving the motive power. The rotation stopper prohibits the anvil from rotating. The condition determiner makes determination about wear condition of the fastening unit based on the predetermined physical quantity detected by the detection unit in a state where the rotation stopper prohibits the anvil from rotating.

A determination processing method according to another aspect of the present disclosure is designed for use in a tool system. The tool system includes: a motor; a fastening unit including a hammer and an anvil and configured to fasten a fastening member by driving a tip tool in rotation; and a control unit for controlling the motor. The determination processing method includes an acquisition step and a condition determination step. The acquisition step includes acquiring a predetermined physical quantity in a state where the hammer that is rotating with motive power supplied from the motor is receiving the motive power. The condition determination step includes making determination about wear condition of the fastening unit based on the predetermined physical quantity acquired in the acquisition step with the anvil prohibited from rotating. The anvil is arranged forward of the hammer in a rotational axis direction of the hammer to receive rotational impact from the hammer.

A program according to still another aspect of the present disclosure is designed to cause one or more processors to perform the determination processing method described above.

### BRIEF DESCRIPTION OF DRAWINGS

FIG. 1A shows a block configuration for a tool system (including a tool and a rotation stopper) according to an exemplary embodiment, and FIG. 1B is a perspective view of a fastening unit provided inside the tool of the tool system;

FIG. 2A is a perspective view illustrating the appearance of the tool as viewed obliquely from a front side thereof, and FIG. 2B is a perspective view illustrating the appearance of the tool as viewed obliquely from a rear side thereof;

FIG. 3 is a perspective view illustrating the appearance of the tool and the rotation stopper;

FIGS. 4A and 4B show waveforms of a current detected by the tool system;

FIG. 5 is a flowchart showing the procedure of operation of the tool system; and

FIG. 6 is a perspective view illustrating the appearance of a variation of the tool system.

### DESCRIPTION OF EMBODIMENTS

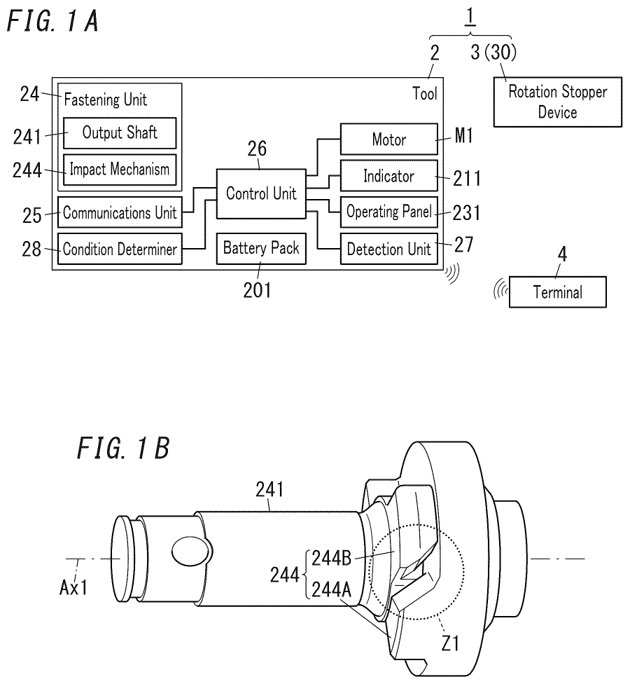

Note that the embodiment and its variations to be described below are only an exemplary one of various embodiments of the present disclosure and its variations and should not be construed as limiting. Rather, the exemplary embodiment and its variations may be readily modified in various manners depending on a design choice or any other factor without departing from a true spirit and scope of the present disclosure. Note that the exemplary embodiment and its variations to be described below may be adopted in combination as appropriate. FIGS. 1B, 2A, 2B, 3, and 6 to be referred to in the following description of embodiments are all schematic representations. Thus, the ratio of the dimensions (including thicknesses) of respective constituent elements illustrated on these drawings does not always reflect their actual dimensional ratio.

### EMBODIMENT

A tool system, determination processing method, and program according to an exemplary embodiment will now be described with reference to FIGS. 1A-5.

### (1) Overview

First, an overview of a tool system 1 according to this embodiment will be described with reference to FIGS. 1A-3.

As shown in FIG. TA, the tool system 1 according to this embodiment includes a motor M1, a fastening unit 24, a control unit 26, a detection unit 27, a rotation stopper 30, and a condition determiner 28.

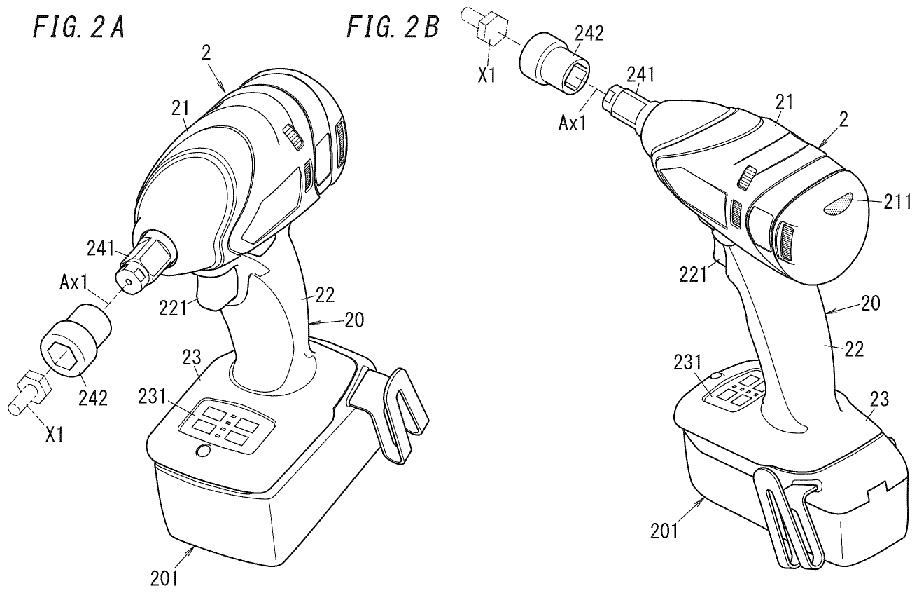

The fastening unit 24 includes: a hammer 244A (refer to FIG. 1B) caused to rotate with motive power supplied from the motor M1; and an anvil 244B (refer to FIG. 1B) arranged forward of the hammer 244A in a rotational axis direction of the hammer 244A to receive rotational impact from the hammer 244A. As used herein, the “rotational axis direction” refers to an axial direction aligned with the rotational axis Ax1 shown in FIGS. 1B, 2A, and 2B.

The fastening unit 24 fastens a fastening member X1 (refer to FIGS. 2A and 2B) by driving a tip tool (such as a socket 242; refer to FIGS. 2A and 2B) in rotation. The fastening unit 24 is supposed to be, for example, provided for a portable tool 2 (such as a handheld tool). The fastening unit 24 is activated by receiving motive power from the motor M1 that is energized with electric power supplied from a battery pack 201, for example. The tool 2 may be, for example, an impact wrench. The fastening unit 24 includes an impact mechanism 244 (refer to FIG. 1A) that performs an impact operation of applying impacting force (impact) to the tip tool such as the socket 242. Making a person who uses the tool 2 (hereinafter referred to as a “user”) use the tool 2 allows a fastening member X1 (such as a bolt or a nut) to be attached to a workpiece (e.g., a target such as a metallic member with a screw hole) as a work target, for example. Note that the tool system 1 does not have to include such a portable tool 2 including the fastening unit 24 but may also include a piece of non-portable equipment (such as a screw tightening robot) including the fastening unit 24.

The control unit 26 controls the motor M1. The detection unit 27 detects a predetermined physical quantity in a state where the hammer 244A is receiving the motive power (from the motor M1). The detection unit 27, as well as the fastening unit 24, is supposed to be provided for the portable tool 2, for example.

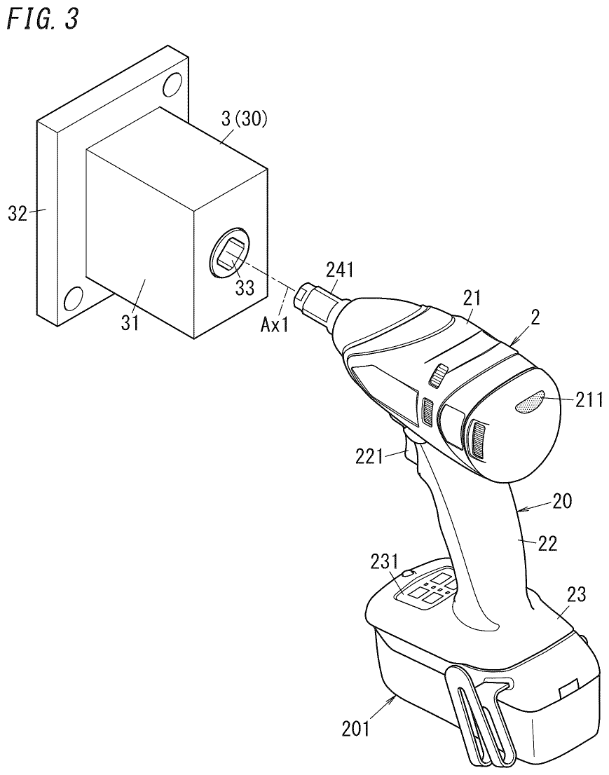

The rotation stopper 30 prohibits the anvil 244B from rotating. The rotation stopper 30 is configured as a device (rotation stopper device 3) which is provided separately from the tool 2 as shown in FIGS. 1A and 3. The rotation stopper device 3 may be, for example, a portable jig. Alternatively, the rotation stopper device 3 may also be a non-portable one. The rotation stopper device 3 may be used, for example, to be fixed on either a workbench in a workplace (such as a construction site) where the tool 2 is used or a structure such as a wall inside a facility (such as a factory).

The condition determiner 28 makes determination about the wear condition of the fastening unit 24 based on the predetermined physical quantity detected by the detection unit 27 in a state where the rotation stopper 30 prohibits the anvil 244B from rotating. The function of the condition determiner 28, as well as the fastening unit 24, is supposed to be provided for the portable tool 2, for example. Alternatively, the function of the condition determiner 28 may also be provided for a device disposed separately from the tool 2. For example, the function of the condition determiner 28 may be provided for either communications equipment or an external server. The communications equipment may be installed in a workplace (such as a construction site) where the tool 2 is used or in a facility (such as a factory). The external server may be installed outside of the workplace or the factory. The external server may include a single or a plurality of server devices. The plurality of server devices may form a cloud computing system.

In the tool system 1 according to this embodiment, determination about the wear condition of the fastening unit 24 is made based on a predetermined physical quantity detected in a state where the rotation stopper 30 prohibits the anvil 244B from rotating and the hammer 244A is receiving motive power. Consequently, the tool system 1 achieves the advantage of contributing to determining the wear condition of the fastening unit 24 more accurately.

As used herein, the expression that the anvil 244B is “prohibited from rotating” does not have to be a state where the anvil 244B is completely immobile but may also refer to a state where the anvil 244B is slightly movable with an angular range on the order of a few degrees. In other words, the rotation stopper 30 may also be configured to substantially prohibit the anvil 244B from rotating with some “allowance” left so that the anvil 244B is movable within an angular range on the order of a few degrees.

A determination processing method according to this embodiment is designed for use in the tool system 1 described above. The determination processing method includes an acquisition step and a condition determination step. The acquisition step includes acquiring a predetermined physical quantity in a state where the hammer 244A that is rotating with motive power supplied from the motor M1 is receiving the motive power. The condition determination step includes making determination about the wear condition of the fastening unit 24 based on the predetermined physical quantity acquired in the acquisition step with the anvil 244B prohibited from rotating.

This determination processing method achieves the advantage of contributing to determining the wear condition of the fastening unit 24 more accurately.

This determination processing method is used on a computer system (i.e., the tool system 1). That is to say, this determination processing method may also be implemented as a program. A program according to an aspect is designed to cause one or more processors to perform the determination processing method described above. The program may be stored in a computer-readable, non-transitory storage medium.

In the following description, the tool 2 will sometimes be described with the direction pointing toward the tip tool (socket 242) which is one of two directions aligned with the axial direction defined by the rotational axis Ax1 of the tool 2 supposed to be a “forward direction” and with the opposite direction pointing away from the tip tool supposed to be a “backward direction.” Nevertheless, these directions are defined simply for the sake of making the following description more easily understandable and should not be construed as limiting the directions in which the tool 2 is supposed to be used.

### (2) Detailed Configuration

Next, a detailed configuration for the tool system 1 according to this embodiment will be described with reference to FIGS. 1A-4B.

### (2.1) Configuration for Tool System

As shown in FIG. 1A, the tool system 1 according to this embodiment includes either a single handheld tool 2 or a plurality of handheld tools 2 and a rotation stopper device 3 (rotation stopper 30). Note that the following description will be focused on a single tool 2 for the sake of convenience of description. That is to say, the rotation stopper 30 is configured as a device (rotation stopper device 3) provided separately from the tool 2. The tool 2 may be used, for example, on an assembly line on which the user performs assembling operations on a predetermined workpiece.

### (2.2) Configuration for Tool

First, a configuration for the tool 2 will be described with reference to FIGS. 1A-2B. As shown in FIG. 1A, the tool 2 includes a motor M1, a fastening unit 24, a communications unit 25, a control unit 26, a detection unit 27, a condition determiner 28, a battery (battery pack 201), an indicator 211, and an operating panel 231. In the example illustrated in FIG. 1A, the condition determiner 28 is provided separately from the control unit 26. However, this is only an example and should not be construed as limiting. Alternatively, the condition determiner 28 may also be provided as one of the functions of the control unit 26. In this embodiment, the battery pack 201 is supposed to be counted among the constituent elements of the tool 2. However, the battery pack 201 does not have to be one of the constituent elements of the tool 2. In other words, the battery pack 201 may be counted out of the constituent elements of the tool 2. For example, the battery pack 201 may be provided separately from the (tool body of the) tool 2 and attached removably to the (tool body of the) tool 2.

As shown in FIGS. 2A and 2B, the tool 2 further includes a body 20 (housing). The body 20 (housing) either houses or holds the motor M1, the fastening unit 24, the control unit 26, and the detection unit 27. In addition, the body 20 (housing) either houses or holds the communications unit 25, the battery (battery pack 201), the indicator 211, and the operating panel 231. The body 20 includes a barrel 21, a grip 22, and an attachment 23 as shown in FIGS. 2A and 2B.

The barrel 21 is formed in a cylindrical shape (e.g., circular cylindrical shape in this embodiment). The grip 22 protrudes in one direction (e.g., downward in FIG. 2A) from a part of the circumferential surface of the barrel 21. The attachment 23 is designed to have the battery pack 201 removably attached thereto. In other words, the barrel 21 and the attachment 23 are coupled together via the grip 22.

At least part of the fastening unit 24 (refer to FIG. 1A) is housed in the barrel 21. An output shaft 241 (to be described later) of the fastening unit 24 protrudes from one axial end surface of the barrel 21.

The grip 22 is apart to be gripped by the user while he or she is performing the operations. The grip 22 is provided with a trigger switch 221. The trigger switch 221 is a switch for controlling the ON/OFF states of the operation of the fastening unit 24. The trigger switch 221 has an initial position and an ON position. Having the trigger switch 221 pushed or pulled to the ON position by the user drives the motor M1 and thereby activates the fastening unit 24. In addition, the trigger switch 221 allows the user to adjust the number of revolutions (rotational velocity) of the fastening unit 24 according to how deep the trigger switch 221 is pulled (i.e., according to its manipulative variable).

The attachment 23 is formed in the shape of a compressed rectangular parallelepiped. The battery pack 201 is attached removably to one side, opposite from the grip 22, of the attachment 23.

The battery pack 201 may be implemented as, for example, a lithium-ion battery. The battery pack 201 supplies electric power to the motor M1, the communications unit 25, the control unit 26, the condition determiner 28, and other components.

The attachment 23 is also provided with the operating panel 231. The operating panel 231 allows the user to enter various types of settings for, and confirm the status of, the tool 2.

That is to say, by operating the operating panel 231, the user is allowed to change the operation mode of the tool 2 or check the remaining capacity of the battery pack 201, for example.

The indicator 211 may be implemented as, for example, a light-emitting diode (LED). The indicator 211 is provided for the other end (i.e., the rear end), opposite from the output shaft 241, of the barrel 21 of the body 20 to allow the user to visually check the indicator 211 easily during his or her operations (refer to FIG. 2B).

The tool 2 according to this embodiment has, as its operation modes, first, second, and third impact modes respectively corresponding to three levels (namely, high, middle, and low) of impacting strength. In addition, the tool 2 according to this embodiment further has, as another operation mode, a drilling mode for fastening a drilling screw. The drilling mode is a mode in which control for decreasing, by detecting a variation in rotational load, the rotational velocity on detecting seating is performed, thereby preventing the fastening member X1 from being damaged by a screwdriver bit (tip tool), for example.

The tool 2 according to this embodiment further has, as still another operation mode, a wear diagnosis mode. The wear diagnosis mode is a mode which may be selected when the user determines the wear condition of the fastening unit 24. The wear diagnosis mode is a mode in which the tool 2 operates in an impact mode with a predetermined level (e.g., a middle level) of impacting strength and which will end automatically when a predetermined amount of time passes (or when impacting force is generated for a predetermined number of times). In the following description, the condition determination is supposed to be made by the condition determiner 28 in the wear diagnosis mode. However, this is only an example and should not be construed as limiting. Alternatively, the tool 2 may have no wear diagnosis mode and the condition determiner 28 may perform the determination processing in, for example, any one of the first to third impact modes.

The operation mode may be changed in accordance with an operating command entered by the user through either the operating panel 231 or, for example, the trigger switch 221 or a dip switch, provided separately from the operating panel 231, whichever is appropriate.

The indicator 211 indicates, by changing the lighting state under the control of the control unit 26, in what operation mode the tool 2 is currently operating. For example, if the tool 2 is operating in the wear diagnosis mode, the indicator 211 turns ON in a predetermined lighting state corresponding to the wear diagnosis mode, thereby notifying the user to that effect.

The fastening unit 24 (refer to FIG. 1A) includes the output shaft 241, a speed reducer mechanism, a drive shaft, the impact mechanism 244, the socket 242, and other members. The fastening unit 24 is configured to receive motive power from the motor M1 driven with the electric power supplied from the battery pack 201 and thereby be activated. The fastening unit 24 fastens the fastening member X1 by driving a tip tool (e.g., the socket 242) in rotation with the motive power supplied from the motor M1.

The speed reducer mechanism transmits the rotational force of the rotary shaft of the motor M1 to a drive shaft. The speed reducer mechanism may be, for example, a planetary gear mechanism and transforms the rotational velocity and torque of the rotary shaft of the motor M1 into a rotational velocity and torque required for turning a screw.

The output shaft 241 is provided forward of the anvil 244B to hold the tip tool (e.g., the socket 242) thereon. The rotational force of the drive shaft is output to the output shaft 241, which transmits the rotational force to the socket 242. The output shaft 241 rotates around the rotational axis Ax1 aligned with the direction in which the output shaft 241 protrudes. That is to say, the fastening unit 24 drives the output shaft 241 in rotation around the rotational axis Ax1. In other words, driving the motor M1 and thereby activating the fastening unit 24 causes torque to be applied to the output shaft 241, thereby rotating the output shaft 241.

A cylindrical socket 242 for rotating the fastening member X1 (such as a bolt or a nut) is attached removably onto the output shaft 241. The socket 242 rotates along with, and around, the output shaft 241. The size of the socket 242 attached to the output shaft 241 may be selected appropriately by the user according to the size of the fastening member X1. According to such a configuration, activating the fastening unit 24 causes the output shaft 241 to rotate, thus causing the socket 242 to rotate along with the output shaft 241. If the socket 242 is fitted onto the fastening member X1 at this time, then the fastening member X1 turns along with the socket 242, thus having the operation of tightening the fastening member X1 done. In this manner, the tool 2 may have the operation of tightening the fastening member X1 done by activating the fastening unit 24.

Optionally, a socket anvil may also be attached, instead of the socket 242, onto the output shaft 241. The socket anvil is also attached removably to the output shaft 241. This allows a bit (such as a screwdriver bit or a drill bit) to be attached to the output shaft 241 via the socket anvil.

The impact mechanism 244 is driven with the motive power supplied from the motor M1. As shown in FIG. 1B, the impact mechanism 244 includes, for example: a hammer 244A, which is supported rotatably by the drive shaft; and an anvil 244B (impact receiving member), which is provided at the rear end of the output shaft 241. The hammer 244A is caused to rotate with the motive power supplied from the motor M1. The hammer 244A applies rotational impacting force to the anvil 244B as the drive shaft rotates. That is to say, the anvil 244B is arranged forward of the hammer 244A in the rotational axis direction of the hammer 244A to receive the rotational impact from the hammer 244A.

The impact mechanism 244 is configured to, when (the work value of) fastening torque exceeds a predetermined level, apply impacting force in the rotational direction to the output shaft 241. This allows the tool 2 to apply greater fastening torque to the fastening member X1. In this embodiment, the socket 242 does not have to be a constituent element of the fastening unit 24. In other words, the socket 242 may be counted out of the constituent elements of the fastening unit 24.

If the user has the fastening operations done repeatedly by using the tool 2, then a particular part Z1 (refer to FIG. 1B) of the fastening unit 24 may be worn down so much as to cause a significant decrease in fastening torque. In this embodiment, the particular part Z1 is supposed to be, for example, a part where the hammer 244A and the anvil 244B are in contact with each other. That is to say, while the hammer 244A performs impact operations repeatedly on the anvil 244B, the surface of the hammer 244A in the particular part Z1 slides on the contact surface of the anvil 244B and applies impacting force to the contact surface of the anvil 244B. Thus, at least one of the hammer 244A or the anvil 244B may be worn little by little as the number of times of use increases. As a result, an increased degree of wear of the particular part Z1 may be one factor that would accelerate the timing to replace the fastening unit 24.

The communications unit 25 is a communications interface configured to be ready to communicate with an external terminal 4 (communications device) shown in FIG. 1A, for example. The communications unit 25 according to this embodiment communicates with the terminal 4 by a wireless communications protocol compliant with a standard such as Wi-Fi®, Bluetooth®, ZigBee®, or a low power radio station requiring no licenses (such as the Specified Low Power Radio Station). Alternatively, the communications unit 25 may also be configured to be ready to communicate with the terminal 4 via wired communication. The terminal 4 may have a management function of managing a single or a plurality of tools 2, for example. The communications unit 25 may, for example, transmit the result of determination made by the condition determiner 28 to the terminal 4 under the control of the control unit 26. The terminal 4 is supposed to be, for example, a device in which a dedicated application software program for communicating with the single or plurality of tools 2 is installed. The terminal 4 may be, for example, a personal computer or a server device. Alternatively, the terminal 4 may also be a mobile device such as a smartphone, a tablet computer, or a laptop computer carried by the user with him or her. The terminal 4 may be one of constituent elements of the tool system 1.

The detection unit 27 detects a predetermined physical quantity in a state where the hammer 244A is receiving the motive power. In this embodiment, the predetermined physical quantity is a current and is specifically a drive current supplied to the motor M1 (hereinafter referred to as a “motor current”). The detection unit 27 includes a detection resistor (current detection unit) for detecting current (motor current) flowing through the coil of the motor M1. The detection unit 27 detects the motor current based on the voltage applied to the detection resistor and a known resistance value of the detection resistor. The predetermined physical quantity does not have to be current but may also be voltage.

Alternatively, the predetermined physical quantity may also be impact or vibration produced in the tool 2. The detection unit 27 may detect the magnitude of the impact and/or an interval between impacts (i.e., an impact cycle). For example, the detection unit 27 may include a shock sensor for detecting acceleration (such as impact or vibration) to output a voltage signal corresponding to the acceleration detected.

Still alternatively, the predetermined physical quantity may also be noise generated by the tool 2. For example, the detection unit 27 may include a volume sensor.

Yet alternatively, the predetermined physical quantity may also be the fastening torque of the tool 2. For example, the detection unit 27 may include a torque sensor or any other suitable device.

Yet alternatively, the predetermined physical quantity may also be the number of revolutions (rotational velocity) of the motor M1. The detection unit 27 may include a hall sensor which outputs a voltage signal according to a rotational position of the rotor of the motor M1.

Yet alternatively, the predetermined physical quantity may also be the voltage (battery voltage) of the battery pack 201. The detection unit 27 may include a voltage detection unit for detecting the voltage between battery terminals.

The detection unit 27 may include two or more types of sensors to detect two or more physical quantities selected from the group consisting of the motor current, impact, vibration, noise, fastening torque, number of revolutions of the motor M1, and battery voltage. The condition determiner 28 to be described later may make determination about the wear condition based on the two or more physical quantities.

The control unit 26 includes, as a major constituent element thereof, a microcontroller including one or more processors and one or more memories. The microcontroller performs the functions of the control unit 26 by making the one or more processors execute a program stored in the one or more memories. The program may be stored in advance in the memory. Alternatively, the program may also be distributed after having been stored in a non-transitory storage medium such as a memory card or downloaded via a telecommunications line. In other words, the program is designed to cause the one or more processors to serve as the control unit 26.

The control unit 26 performs the motor control, communication control, notification control functions, and other functions. The control unit 26 controls the motor M1. Specifically, the control unit 26 controls the motor M1 to cause the output shaft 241 to rotate at a rotational velocity determined by the press depth of the trigger switch 221.

In addition, the control unit 26 also controls the motor M1 such that the fastening torque becomes equal to a preset torque value. In this embodiment, the control unit 26 has a torque estimating function of estimating the magnitude of the fastening torque. The control unit 26 estimates, until the estimated value of the fastening torque reaches a seating determination level, the magnitude of the fastening torque based on, for example, the cycle of the impacting force applied by the impact mechanism 244. When the estimated value of the fastening torque reaches the seating determination level, the control unit 26 estimates the magnitude of the fastening torque based on the number of impacts applied by the impact mechanism 244. When finding the number of impacts applied by the impact mechanism 244 has reached a threshold number of times based on the preset torque value, the control unit 26 determines that the fastening torque have reached the preset torque value, and stops running the motor M1. This allows the fastening unit 24 to fasten the fastening member X1 with fastening torque that exactly matches the preset torque value unless there is any inconvenience (e.g., the fastening torque has reached the seating determination level erroneously even though the fastening member X1 has actually not been seated yet). In the wear diagnosis mode, the control unit 26 does not have to perform the processing concerning the seating determination.

The condition determiner 28 includes, as a major constituent element thereof, a microcontroller including one or more processors and one or more memories. The microcontroller performs the functions of the condition determiner 28 by making the one or more processors execute a program stored in the one or more memories. The program may be stored in advance in the memory. Alternatively, the program may also be distributed after having been stored in a non-transitory storage medium such as a memory card or downloaded via a telecommunications line. In other words, the program is designed to cause the one or more processors to serve as the condition determiner 28.

If the user turns ON the trigger switch 221 while the wear diagnosis mode is selected, for example, the control unit 26 starts performing driving control on the motor M1 and instructs the condition determiner 28 to make determination about the wear condition. In this embodiment, the wear diagnosis mode is used on the supposition that the anvil 244B is prohibited from rotating by the rotation stopper 30 (such a state will be hereinafter referred to as a “rotation prohibited state”).

The condition determiner 28 acquires information about the predetermined physical quantity (e.g., motor current in this embodiment) detected by the detection unit 27 in a state where the hammer 244A is receiving motive power from the motor M1 while the anvil 244B is in the rotation prohibited state. That is to say, the condition determiner 28 performs processing concerning the acquisition step of the determination processing method.

The condition determiner 28 makes determination about the wear condition of the fastening unit 24 by reference to the information about the motor current. That is to say, the condition determiner 28 performs processing concerning the condition determination step of the determination processing method. The hammer 244A applies a rotational impact to the anvil 244B but the anvil 244B itself is not in a rotational state. Thus, the load applied mutually to the hammer 244A and the anvil 244B is kept substantially constant.

The tool 2 preferably has a notification function of notifying the user unless the anvil 244B is in the rotation prohibited state while the wear diagnosis mode is selected.

The condition determiner 28 measures a drive current (motor current) during, for example, a prescribed period that begins at a point in time when the rotational impact starts to be applied from the hammer 244A to the anvil 244B and makes calculations.

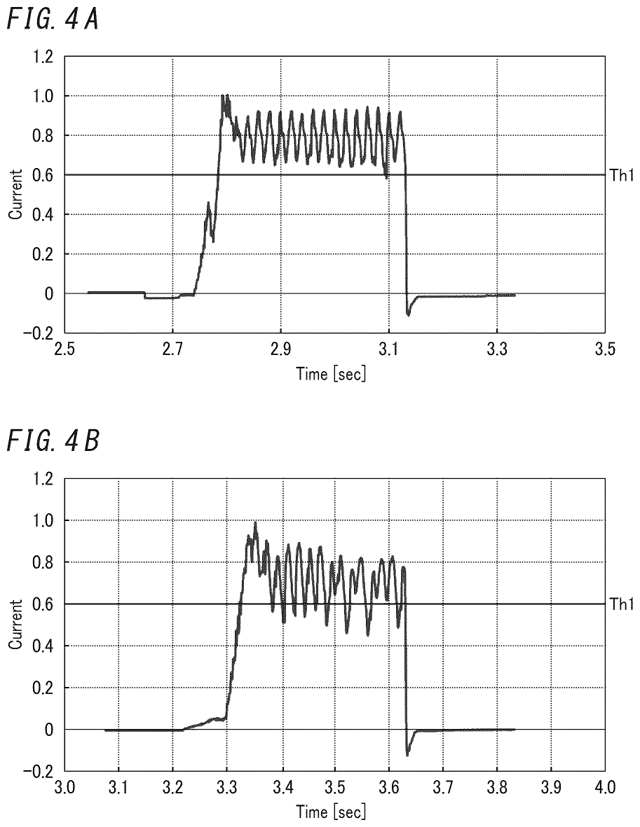

With this regard, FIGS. 4A and 4B show exemplary waveform charts, each showing the waveform of a motor current (as a predetermined physical quantity) which is detected by the (detection unit 27 of the) tool system 1 during the prescribed period that begins at a point in time when the rotational impact starts to be applied from the hammer 244A to the anvil 244B and ends at another point in time when the rotational impact finishes being applied from the hammer 244A to the anvil 244B. In the example shown in FIGS. 4A and 4B, the prescribed period has a duration of approximately 0.4 seconds.

FIG. 4A is a waveform chart of a motor current in a situation where a fastening unit 24 in a normal condition in which the fastening unit 24 has not been worn significantly yet (hereinafter referred to as a “normal product”). On the other hand, FIG. 4B is a waveform chart of a motor current in a situation where a fastening unit 24 in a condition in which the fastening unit 24 has already been worn significantly (hereinafter referred to as a “worn product”). In FIGS. 4A and 4B, the abscissa indicates the time, and the ordinate indicates the dimension of the (motor) current. In the following description, such a condition of the fastening unit 24 which has been worn excessively will be hereinafter simply referred to as “abnormality” or an “abnormal condition.”

The following Table 1 summarizes exemplary results of calculations (including standard deviation, p2p, max (maximum value), min (minimum value), and the number of times) obtained by using the condition determiner 28 to measure and calculate the motor current in a fastening unit 24 (normal product) such as the one shown in FIG. 4A. In Table 1, the column “standard deviation” is an index to the degree of variation in the motor current that goes up and down during the prescribed period (of approximately 0.4 seconds); and the column “p2p (peak to peak)” indicates the difference between max (maximum value) and min (minimum value) of the motor current that goes up and down during the prescribed period. Note that the minimum value is supposed to be the minimum value of the current while the impact is being applied (e.g., a period with a duration of approximately 2.8-3.1 seconds in the example shown in FIG. 4A). In Table 1, the column “number of times” indicates the number of times the motor current waveform that goes up and down during the prescribed period has crossed a predetermined value Th1 (of 0.6; refer to FIG. 4A) (hereinafter referred to as the “number of times of crosses”) since the motor current waveform has exceeded the predetermined value Th1 for the first time and until the motor current waveform falls short of the predetermined value Th1 for the last time. In the example shown in FIG. 4A, the motor current waveform crosses the predetermined value Th1 of 0.6 twice (specifically, before and after a local minimum value in the vicinity of 3.1 seconds). Note that the “number of times” does not have to be the number of times of crosses but may also be the number of times that the local minimum value of the motor current has fallen short of the predetermined value Th1 during the prescribed period (hereinafter referred to as the “number of times of local minimum values”). The condition determiner 28 measures and calculates the motor current twenty times during the prescribed period as shown in the following Table 1 on the same fastening unit 24 (normal product). Note that the term “Ave” on the last row of Table 1 indicates average values of the respective items, each of which has been measured twenty times.

TABLE 1

| | Standard | | | | Number |
|---|---|---|---|---|---|
| | deviation | p2p | max | min | of times |
| 1 | 0.092 | 0.36 | 0.94 | 0.58 | 2 |
| 2 | 0.104 | 0.36 | 0.95 | 0.59 | 2 |
| 3 | 0.076 | 0.27 | 0.93 | 0.66 | 2 |
| 4 | 0.074 | 0.29 | 0.93 | 0.64 | 2 |
| 5 | 0.075 | 0.28 | 0.92 | 0.64 | 2 |
| 6 | 0.065 | 0.26 | 0.89 | 0.64 | 2 |
| 7 | 0.067 | 0.25 | 0.90 | 0.64 | 2 |
| 8 | 0.062 | 0.23 | 0.87 | 0.64 | 2 |
| 9 | 0.064 | 0.26 | 0.90 | 0.65 | 2 |
| 10 | 0.062 | 0.24 | 0.90 | 0.66 | 2 |
| 11 | 0.060 | 0.24 | 0.89 | 0.64 | 2 |
| 12 | 0.062 | 0.25 | 0.90 | 0.64 | 2 |
| 13 | 0.064 | 0.25 | 0.89 | 0.64 | 2 |
| 14 | 0.071 | 0.26 | 0.89 | 0.63 | 2 |
| 15 | 0.070 | 0.27 | 0.93 | 0.65 | 2 |
| 16 | 0.076 | 0.27 | 0.90 | 0.63 | 2 |
| 17 | 0.110 | 0.39 | 0.92 | 0.54 | 16 |
| 18 | 0.094 | 0.36 | 0.94 | 0.58 | 2 |
| 19 | 0.093 | 0.33 | 0.92 | 0.58 | 4 |
| 20 | 0.106 | 0.36 | 0.94 | 0.59 | 4 |
| Ave | 0.077 | 0.29 | 0.91 | 0.62 | 2.9 |

TABLE 2

| | Standard | | | | Number |
|---|---|---|---|---|---|
| | deviation | p2p | max | min | of times |
| 1 | 0.108 | 0.44 | 0.89 | 0.45 | 20 |
| 2 | 0.106 | 0.40 | 0.88 | 0.48 | 18 |
| 3 | 0.107 | 0.46 | 0.90 | 0.44 | 22 |
| 4 | 0.106 | 0.36 | 0.88 | 0.52 | 20 |
| 5 | 0.104 | 0.44 | 0.87 | 0.43 | 14 |
| 6 | 0.106 | 0.39 | 0.88 | 0.49 | 20 |
| 7 | 0.109 | 0.45 | 0.88 | 0.44 | 16 |
| 8 | 0.112 | 0.41 | 0.87 | 0.46 | 18 |
| 9 | 0.105 | 0.41 | 0.88 | 0.47 | 18 |
| 10 | 0.101 | 0.40 | 0.86 | 0.46 | 16 |
| 11 | 0.105 | 0.41 | 0.86 | 0.45 | 16 |
| 12 | 0.105 | 0.45 | 0.87 | 0.42 | 16 |
| 13 | 0.104 | 0.41 | 0.86 | 0.45 | 18 |
| 14 | 0.103 | 0.41 | 0.86 | 0.45 | 18 |
| 15 | 0.098 | 0.41 | 0.86 | 0.44 | 20 |
| 16 | 0.103 | 0.39 | 0.87 | 0.48 | 22 |
| 17 | 0.114 | 0.45 | 0.86 | 0.41 | 18 |
| 18 | 0.102 | 0.43 | 0.85 | 0.42 | 18 |
| 19 | 0.112 | 0.45 | 0.88 | 0.43 | 20 |
| 20 | 0.112 | 0.46 | 0.88 | 0.43 | 26 |
| Ave | 0.106 | 0.42 | 0.87 | 0.45 | 18.7 |

Comparing the results of the normal product (shown in Table 1) with the results of the worn product (shown in Table 2), it can be seen that the standard deviation of the motor current is larger in the worn product (shown in Table 2). As for the maximum value, there rarely is a significant difference between the normal product (shown in Table 1) and the worn product (shown in Table 2). The p2p value is larger in the worn product (shown in Table 2) than in the normal product (shown in Table 1). The minimum value is smaller in the worn product (shown in Table 2) than in the normal product (shown in Table 1). In addition, it can also be seen that the number of times (the number of times of crosses) is much larger in the worn product (shown in Table 2) than in the normal product (shown in Table 1). Considering these results of comparison, it can be said that either the number of times of crosses or the number of times of local minimum values is preferably used as data for determining the wear condition.

Thus, the condition determiner 28 according to this embodiment makes determination about the wear condition of the fastening unit 24 based on the number of times the local minimum value of the drive current (motor current) falls short of a predetermined value (i.e., the number of times of local minimum values) during a prescribed period that begins at a point in time when the rotational impact starts to be applied from the hammer 244A to the anvil 244B. Alternatively, the condition determiner 28 may also make determination about the wear condition of the fastening unit 24 based on the number of times of crosses. The processing of making determination based on the number of times of local minimum values (or the number of times of crosses) will be hereinafter referred to as “first determination processing.” If the number of times of local minimum values, i.e., the number of times the local minimum value of the motor current has fallen short of the predetermined value Th1 (of 0.6 in this example), turns out to be less than a predefined number of times as a result of the first determination processing, then the condition determiner 28 determines the wear condition of the fastening unit 24 to be a normal condition. On the other hand, if the number of times of local minimum values, i.e., the number of times the local minimum value of the motor current has fallen short of the predetermined value Th1, turns out to be equal to or greater than the predefined number of times as a result of the first determination processing, then the condition determiner 28 determines the wear condition of the fastening unit 24 to be an abnormal condition.

Optionally, the condition determiner 28 may count either the number of times of local minimum values or the number of times of crosses during the prescribed period multiple times (e.g., twenty times in the example shown in Tables 1 and 2) and compare the average value of the results obtained in the multiple times with a predefined number of times to determine whether the wear condition of the fastening unit 24 is a normal condition or an abnormal condition. For instance, in the example shown in Table 1, the condition determiner 28 may compare the average value of 2.9 of the number of times of crosses with a predefined number of times that has been set in advance for the number of times of crosses. On the other hand, in the example shown in Table 2, the condition determiner 28 may compare the average value of 18.7 of the number of times of crosses with the predefined number of times that has been set in advance for the number of times of crosses.

Alternatively, the condition determiner 28 may also make determination about the wear condition of the fastening unit 24 based on the standard deviation of the drive current (motor current) during the prescribed period that begins at a point in time when the rotational impact starts to be applied from the hammer 244A to the anvil 244B. The processing of making determination based on the standard deviation will be hereinafter referred to as “second determination processing.” If the standard deviation of the motor current turns out to be less than a certain numerical value as a result of the second determination processing, then the condition determiner 28 determines the wear condition of the fastening unit 24 to be a normal condition. On the other hand, if the standard deviation of the motor current turns out to be equal to or greater than the certain numerical value as a result of the second determination processing, then the condition determiner 28 determines the wear condition of the fastening unit 24 to be an abnormal condition.

Optionally, the condition determiner 28 may measure the standard deviation of the motor current during the prescribed period multiple times (e.g., twenty times in the example shown in Tables 1 and 2) and compare the average value of the standard deviations for the multiple times with the certain numerical value to determine whether the wear condition of the fastening unit 24 is a normal condition or an abnormal condition. For instance, in the example shown in Table 1, the condition determiner 28 may compare the average value of 0.077 with the certain numerical value. In the example shown in Table 2, the condition determiner 28 may compare the average value of 0.106 with the certain numerical value.

Still alternatively, the condition determiner 28 may also make determination about the wear condition of the fastening unit 24 based on the average value of the drive current (motor current) during the prescribed period that begins at a point in time when the rotational impact starts to be applied from the hammer 244A to the anvil 244B. The processing of making determination based on the average value will be hereinafter referred to as “third determination processing.” As used herein, the average value of the motor current refers to the average value of instantaneous values during the prescribed period. If the average value of the motor current turns out to fall within a predetermined normal range as a result of the third determination processing, then the condition determiner 28 determines the wear condition of the fastening unit 24 to be a normal condition. On the other hand, if the average value of the motor current turns out to fall outside of the predetermined normal range as a result of the third determination processing, then the condition determiner 28 determines the wear condition of the fastening unit 24 to be an abnormal condition.

Optionally, the condition determiner 28 may measure the average value of the motor current during the prescribed period multiple times and compare the average value of the average values for the multiple times with the predetermined normal range to determine whether the wear condition of the fastening unit 24 is a normal condition or an abnormal condition.

Yet alternatively, the condition determiner 28 may also make determination about the wear condition based on at least one of the maximum value, the minimum value, or the difference (p2p) between the maximum and minimum values of the drive current (motor current) during the prescribed period that begins at a point in time when the rotational impact starts to be applied from the hammer 244A to the anvil 244B. The processing of making determination based on at least one of the maximum value, the minimum value, or p2p will be hereinafter referred to as “fourth determination processing.” If p2p, for example, turns out to be less than a predefined value as a result of the fourth determination processing, then the condition determiner 28 determines the wear condition of the fastening unit 24 to be a normal condition. On the other hand, if p2p turns out to be equal to or greater than the predefined value as a result of the fourth determination processing, then the condition determiner 28 determines the wear condition of the fastening unit 24 to be an abnormal condition.

Optionally, the condition determiner 28 may measure p2p during the prescribed period multiple times and compare the average value of p2p for the multiple times with the predefined value to determine whether the wear condition of the fastening unit 24 is a normal condition or an abnormal condition. For instance, in the example shown in Table 1, the condition determiner 28 may compare the average value of 0.29 with the predefined value. In the example shown in Table 2, the condition determiner 28 may compare the average value of 0.42 with the predefined value.

In this embodiment, the condition determiner 28 is supposed to perform, as an example, only the first processing out of the first to fourth processing. However, this is only an example and should not be construed as limiting. Alternatively, the condition determiner 28 may also perform more than one type of processing selected from the first to fourth processing. In a situation where the condition determiner 28 performs two or more types of processing selected from the first to fourth processing, if the result of at least one of the two or more types of determination processing indicates the abnormal condition, then the final decision may be regarded as “abnormal.” Alternatively, if the results of two or more types of determination processing all indicate the abnormal condition, then the final decision may be regarded as “abnormal.”

The control unit 26 notifies, using the indicator 211, the user of the decision made by the condition determiner 28. If the decision made by the condition determiner 28 indicates the “normal condition,” then the indicator 211 is lit in blue continuously, for example. On the other hand, if the decision made by the condition determiner 28 indicates the “abnormal condition,” then the indicator 211 flashes in red, for example.

Alternatively or additionally, the control unit 26 may also notify, using the terminal 4, the user of the decision made by the condition determiner 28. For example, in accordance with the decision, the terminal 4 may display, on the display device, a message such as “wear condition is normal” or “it is about time that anvil or hammer were replaced.”

Still alternatively, the decision made by the condition determiner 28 may be emitted as a sound (e.g., emitted as a synthesized voice message).

On being notified by either the indicator 211 or the terminal 4 that the wear condition is abnormal or that it is about time to make replacement, the user is recommended to replace the hammer 244A and/or the anvil 244B.

### (2.3) Configuration for Rotation Stopper

In this embodiment, the rotation stopper 30 may be configured, for example, as a rotation stopper device 3 (refer to FIG. 3) which is provided separately from the tool 2 as described above.

The rotation stopper device 3 (rotation stopper 30) is configured to prohibit the anvil 244B from rotating. Note that the rotation stopper device 3 (rotation stopper 30) is configured to allow the anvil 244B to move in a thrusting direction (i.e., a direction aligned with the rotational axis Ax1).

Specifically, the rotation stopper device 3 includes a body 31, a base 32, and a hole (recess) 33 as shown in FIG. 3.

The body 31 has a substantially rectangular parallelepiped shape. The body 31 may be made of a metallic material, for example, but its material is not limited to any particular one. The base 32 has a substantially rectangular plate shape. The base 32 may be made of a metallic material, for example, but its material is not limited to any particular one. The base 32 is attached to one end surface of the body 31 to support the body 31 thereon. The hole 33 is provided for the other end surface, opposite from the one end surface with the base 32, of the body 31. The hole 33 is configured to substantially stop the output shaft 241 from rotating by receiving the tip of the output shaft 241 of the tool 2 inserted thereto. The opening of the hole 33 has substantially the same shape as the tip of the output shaft 241. The dimension of the opening of the hole 33 is large enough to receive the tip of the output shaft 241 inserted thereto with almost no gap left. The rotation stopper device 3 (rotation stopper 30) prohibits the anvil 244B from rotating by making the hole 33 stop the output shaft 241 from rotating.

Optionally, the hole 33 may be made of an elastic material to prevent the tip of the output shaft 241 from being scratched when the tip of the output shaft 241 abuts on the inner circumferential surface of the hole 33 to substantially stop its rotation. For example, an elastic member with the hole 33 may be fitted into the recess of the body 31. Alternatively, the body 31 itself may be an elastic member. Optionally, the output shaft 241 may slightly turn by a few degrees inside the hole 33 to distort the inner circumferential surface of the hole 33 and return to its original position due to the elastic recovery force of the inner circumferential surface.

The rotation stopper device 3 is supposed to be used, for example, with the base 32 fixed with screws onto a wall, a workbench, or any other structure.

Optionally, the rotation stopper device 3 may include a sensor for detecting the insertion of the output shaft 241 into the hole 33. The rotation stopper device 3 may include a communications unit for transmitting tool detection information, including the result of detection by the sensor, to the communications unit 25 of the tool 2 either wirelessly or via a cable. When the wear diagnosis mode is selected, the control unit 26 of the tool 2 determines, in accordance with the tool detection information provided by the rotation stopper device 3, whether the anvil 244B is in the rotation prohibited state. If the control unit 26 determines that the anvil 244B not be in the rotation prohibited state when the wear diagnosis mode is selected, then the control unit 26 prompts the user to insert the output shaft 241 into the hole 33 of the rotation stopper device 3. The control unit 26 may perform control not to drive the motor M1 even if the trigger switch 221 is turned ON by the user unless the anvil 244B is in the rotation prohibited state. Optionally, a sensor for detecting the rotation prohibited state of the anvil 244B may be provided for the tool 2.

### (3) Operation

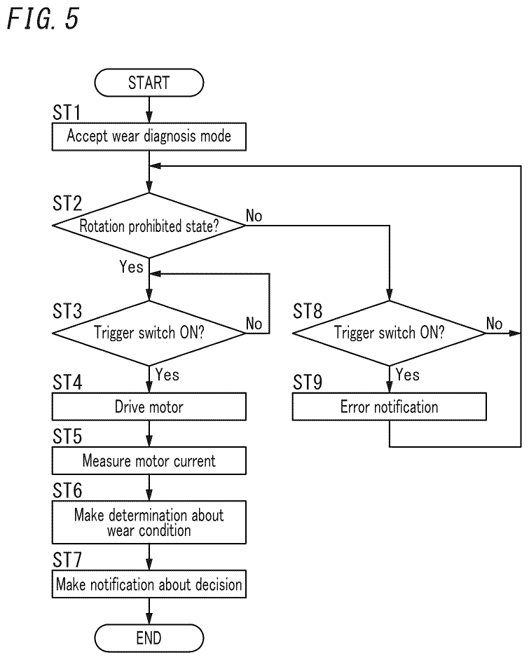

Next, it will be described with reference to FIG. 5 how the tool system 1 according to this embodiment operates when the user makes a diagnosis about the wear condition of the fastening unit 24. FIG. 5 is a flowchart showing an exemplary procedure of operation of the tool system 1. Note that the flowchart shown in FIG. 5 shows only an exemplary procedure of operation of the tool system 1 and should not be construed as limiting. Optionally, the processing steps shown in FIG. 5 may be performed in a different order from the illustrated one, some of the processing steps shown in FIG. 5 may be omitted as appropriate, and/or an additional processing step may be performed as needed.

In the following example, the tool 2 is supposed to measure and calculate the motor current during a prescribed period only once and perform the processing of making determination about the wear condition of the fastening unit 24 based on the result of the calculation that has been performed once. That is to say, in the wear diagnosis mode, the tool 2 is supposed to start applying the rotational impact every time the trigger switch 221 is turned ON, and continue to apply the rotational impact until the prescribed period passes since the rotational impact started to be applied. Then, the tool 2 is supposed to measure and calculate the motor current during the prescribed period as one session and perform the determination processing with respect to the result of calculation for the one session.

First, the user enters, using the operating panel 231, for example, an operating command that the operation mode of the tool 2 be changed to the wear diagnosis mode. As a result, the tool 2 accepts the operating command of changing the operation mode to the wear diagnosis mode (in Step ST1).

Next, the user inserts the tip of the output shaft 241 of the tool 2 into the hole 33 of the rotation stopper device 3. At this time, the (control unit 26 of the) tool 2 determines, in accordance with the tool detection information that the tool 2 has received from the rotation stopper device 3, whether or not the anvil 244B is in the rotation prohibited state (in Step ST2).

When determining that the anvil 244B be in the rotation prohibited state (if the answer is YES in Step ST2), the tool 2 waits until the trigger switch 221 is turned ON (if the answer is NO in Step ST3). When the trigger switch 221 is turned ON (if the answer is YES in Step ST3), the motor M1 starts to be driven (in Step ST4). As a result, the hammer 244A applies rotational impact, of which the strength corresponds to the wear diagnosis mode, to the anvil 244B. Nevertheless, since the rotation of the output shaft 241 is substantially stopped by the hole 33 of the rotation stopper device 3, neither the output shaft 241 nor the anvil 244B rotates. In the wear diagnosis mode, the number of revolutions (rotational velocity) of the motor M1 is supposed to be maintained at a constant value irrespective of the depth to which the trigger switch 221 has been pulled (i.e., the manipulative variable thereof).

The tool 2 makes the detection unit 27 measure the motor current during the prescribed period in a state where the hammer 244A is receiving motive power from the motor M1 while the anvil 244B is in the rotation prohibited state (in Step ST5). Then, the (condition determiner 28 of the) tool 2 performs determination processing about the wear condition of the fastening unit 24 (such as the first determination processing) based on the motor current during the prescribed period (in Step ST6). The tool 2 notifies, using either the indicator 211 or the terminal 4, the user of the decision made about the wear condition of the fastening unit 24 (in Step ST7). Note that in this embodiment, when the prescribed period passes to finish measuring the motor current, the tool 2 finishes driving the motor M1 automatically.

The wear condition of the fastening unit 24 may be diagnosed either before the operations of fastening the fastening member X1 are performed or during a regular maintenance, whichever is appropriate. For example, if the wear condition of the fastening unit 24 is diagnosed as the normal condition, then the user changes the operation mode of the tool 2 from the wear diagnosis mode to the first impact mode, for instance, to perform actual operations (e.g., the operations of fastening the fastening member X1) using the tool 2. On the other hand, if the wear condition of the fastening unit 24 is diagnosed as abnormal condition, then the user preferably refrains from using the tool 2 until the fastening unit 24 is replaced.

Meanwhile, if the trigger switch 221 is turned ON (if the answer is YES in Step ST8) even though a decision is made in Step ST2 that the anvil 244B not be in the rotation prohibited state (even if the answer is NO in Step ST2), then the tool 2 makes error notification (in Step ST9). The tool 2 makes the error notification using the indicator 211, for example, to prompt the user to set (insert) the output shaft 241 into the hole 33 of the rotation stopper device 3. Note that if a decision is made that the anvil 244B not be in the rotation prohibited state (if the answer is NO in Step ST2) and the trigger switch 221 is not turned ON (if the answer is NO in Step ST8), then the tool 2 returns to Step ST2.

### (4) Advantages

As can be seen from the foregoing description, the tool system 1 makes determination about the wear condition of the fastening unit 24 based on a predetermined physical quantity (such as a motor current) detected in a state where the anvil 244B is prohibited from rotating and the hammer 244A is receiving motive power. That is to say, even though the hammer 244A is applying rotational impact to the anvil 244B, the anvil 244B itself is prohibited from rotating by the rotation stopper 30, and therefore, the load applied to the hammer 244A and the anvil 244B is maintained at substantially a constant value. Consequently, the tool system 1 achieves the advantage of contributing to determining the wear condition of the fastening unit 24 more accurately.

In addition, the tool system 1 may make determination more accurately than in a situation where the determination about the wear condition of the fastening unit 24 is made based on a physical quantity (such as a motor current) detected during the actual operations (e.g., while the fastening member X1 is being fastened). In particular, during actual operations (e.g., while the fastening member X1 is being fastened), it may be difficult to maintain the load applied to the hammer 244A and the anvil 244B at a substantially constant value depending on the type of the fastening member X1 and the type of the workpiece to which the fastening member X1 is to be attached. Consequently, during the actual operations, it may be difficult to sense the difference resulting from the wear condition. In this respect, it can be said that this tool system 1 does have such a configuration that makes it easier to sense the difference resulting from the wear condition.

With this regard, the present inventors carried out experiments about the life of the tool 2. As a result, the present inventors discovered that as the progress of deterioration of the fastening unit 24 due to wear caused an increasingly significant decline in the fastening torque value, a certain correlation was observed between the torque value and the current value (such as the average value) of the motor current. That is to say, the present inventors discovered that as the torque value decreased, the current value of the motor current also decreased accordingly. Based on this ground, the tool system 1 makes measurements and calculations about the motor current to make determination about the wear condition of the fastening unit 24. Consequently, this allows the wear condition to be determined more accurately.

### (Variations)

Next, variations of the exemplary embodiment will be enumerated one after another. Note that the variations to be described below may be adopted in combination as appropriate.

The functions of the tool system 1 according to the exemplary embodiment described above may also be implemented as, for example, a determination processing method, a computer program, or a non-transitory storage medium on which the computer program is stored.

The tool system 1 (in particular, the control unit 26 and the condition determiner 28 thereof) according to the present disclosure includes a computer system. The computer system includes a processor and a memory as principal hardware components thereof. The computer system performs the functions of the tool system 1 according to the present disclosure by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits such as an IC or an LSI include integrated circuits called a “system LSI,” a “very-large-scale integrated circuit (VLSI),” and an “ultra-large-scale integrated circuit (ULSI).” Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be aggregated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

In the embodiment described above, the plurality of functions of the tool system 1 are integrated together in a single device. However, this is not an essential configuration for the tool system 1. Alternatively, those constituent elements of the tool system 1 may be distributed in multiple different housings.

Conversely, the plurality of functions of the tool system 1 may be integrated together in a single housing. Still alternatively, at least some functions of the tool system 1 (e.g., some functions of the tool system 1) may be implemented as a cloud computing system as well.

In the embodiment described above, the tool 2 has the function of the condition determiner 28. However, this is only an example and should not be construed as limiting. Alternatively, the function of the condition determiner 28 may be provided for another device separately from the tool 2. For example, the function of the condition determiner 28 may also be performed by a server or a cloud computing system.

In the embodiment described above, the rotation stopper 30 is configured to prohibit the anvil 244B from rotating but allow the anvil 244B to move in the thrusting direction. Alternatively, the rotation stopper 30 may also be configured to prohibit the anvil 244B from not only rotating but also moving in the thrusting direction as well.

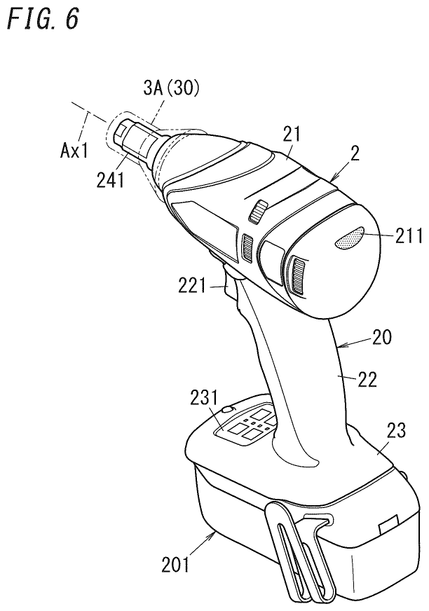

In the embodiment described above, the rotation stopper 30 is configured as a rotation stopper device 3 (refer to FIG. 3) provided separately from the tool 2. Alternatively, the rotation stopper 30 may also be configured as an output shaft locking portion 3A, which is one of constituent elements of the tool 2, as shown in FIG. 6, for example. The output shaft locking portion 3A is a cap member to be attached to the body 20 to cover the output shaft 241 on the circumference. Optionally, the output shaft locking portion 3A may be attached removably to the body 20. For example, the inner circumferential surface of the output shaft locking portion 3A may be provided with projections. In that case, fitting the projections into a recess on the outer peripheral surface of the output shaft 241 causes the output shaft 241 to be locked, thus realizing rotation prohibited state for the anvil 244B. In this case, the tool 2 preferably has the detection function of determining whether the output shaft 241 (along with the anvil 244B) is being locked by the output shaft locking portion 3A while the wear diagnosis mode is selected and the notification function of making notification about the result of detection. The tool 2 may perform control not to drive the motor M1 even if the trigger switch 221 is turned ON by the user unless the output shaft 241 (along with the anvil 244B) is locked by the output shaft locking portion 3A while the wear diagnosis mode is selected.

Note that the tool system 1 does not have to be applied to the assembly line, on which workpieces are assembled at a factory, but may find any other application as well.

In the embodiment described above, the tool 2 is an impact wrench. However, the tool 2 does not have to be an impact wrench but may also be a screwdriver (including an impact screwdriver) for use to fasten screws (as fastening members X1), for example. In that case, a bit (such as a screwdriver bit) is attached to the tool 2 instead of the socket 242. Furthermore, the tool 2 does not have to be powered by the battery pack 201 but may also be powered by an AC power supply (commercial power supply).

Furthermore, the indicator 211 does not have to be a light-emitting unit such as an LED but may also be implemented as an image display device such as a liquid crystal display or an organic electroluminescent (EL) display. In that case, Step ST7 of making notification about the result of decision and Step ST9 of error notification shown in FIG. 5 may be performed by displaying messages on the screen of the indicator 211. Optionally, the tool 2 may include a sound emitter such as a loudspeaker or a buzzer. In that case, Step ST7 of making notification about the result of decision and Step ST9 of error notification shown in FIG. 5 may be performed by emitting a sound from the sound emitter. Still alternatively, the tool 2 may also include a vibrator that produces vibration. In that case, Step ST7 of making notification about the decision and Step ST9 of error notification shown in FIG. 5 may be performed by producing vibration from the vibrator.

### (Recapitulation)

The exemplary embodiment and its variations described above are specific implementations of the following aspects of the present disclosure.

A tool system (1) according to a first aspect includes a motor (M1), a fastening unit (24), a control unit (26), a detection unit (27), a rotation stopper (30), and a condition determiner (28). The fastening unit (24) includes: a hammer (244A) caused to rotate with motive power supplied from the motor (M1); and an anvil (244B) arranged forward of the hammer (244A) in a rotational axis direction of the hammer (244A) to receive rotational impact from the hammer (244A). The fastening unit (24) fastens a fastening member (X1) by driving a tip tool (socket 242) in rotation. The control unit (26) controls the motor (M1). The detection unit (27) detects a predetermined physical quantity in a state where the hammer (244A) is receiving the motive power. The rotation stopper (30) prohibits the anvil (244B) from rotating. The condition determiner (28) makes determination about wear condition of the fastening unit (24) based on the predetermined physical quantity detected by the detection unit (27) in a state where the rotation stopper (30) prohibits the anvil (244B) from rotating.

According to this aspect, determination about the wear condition of the fastening unit (24) is made based on a predetermined physical quantity detected in a state where the rotation stopper (30) prohibits the anvil (244B) from rotating and the hammer (244A) is receiving motive power. Consequently, the tool system (1) achieves the advantage of contributing to determining the wear condition of the fastening unit (24) more accurately.

In a tool system (1) according to a second aspect, which may be implemented in conjunction with the first aspect, the predetermined physical quantity is a drive current supplied to the motor (M1).

This aspect further improves the degree of accuracy of decision by determining the wear condition based on the drive current for the motor (M1), because there is a correlation between a variation in torque (value) caused by the deterioration of the wear condition and a variation in the drive current for the motor (M1).

In a tool system (1) according to a third aspect, which may be implemented in conjunction with the second aspect, the condition determiner (28) makes the determination based on a numerical number of times a local minimum value of the drive current has fallen short of a predetermined value during a prescribed period that begins at a point in time when the rotational impact starts to be applied from the hammer (244A) to the anvil (244B).

This aspect allows the wear condition of the fastening unit (24) to be determined more accurately.

In a tool system (1) according to a fourth aspect, which may be implemented in conjunction with the second or third aspect, the condition determiner (28) makes the determination based on a standard deviation of the drive current during a prescribed period that begins at a point in time when the rotational impact starts to be applied from the hammer (244A) to the anvil (244B).

This aspect allows the wear condition of the fastening unit (24) to be determined more accurately.

In a tool system (1) according to a fifth aspect, which may be implemented in conjunction with any one of the second to fourth aspects, the condition determiner (28) makes the determination based on an average value of the drive current during a prescribed period that begins at a point in time when the rotational impact starts to be applied from the hammer (244A) to the anvil (244B).

This aspect allows the wear condition of the fastening unit (24) to be determined more accurately.

A tool system (1) according to a sixth aspect, which may be implemented in conjunction with any one of the first to fifth aspects, further includes a tool (2) designed to be used as a handheld tool. The tool (2) includes a housing (body 20) that either houses or holds the motor (M1), the fastening unit (24), the control unit (26), and the detection unit (27). The rotation stopper (30) is configured as a device (rotation stopper device 3) provided separately from the tool (2).

This aspect may reduce an increase in the overall size of the tool (2) compared to a situation where the tool (2) is provided with the rotation stopper (30).

In a tool system (1) according to a seventh aspect, which may be implemented in conjunction with the sixth aspect, the fastening unit (24) further includes an output shaft (241) arranged forward of the anvil (244B) to hold the tip tool (socket 242) thereon. The rotation stopper (30) has a hole (33), to which a tip of the output shaft (241) is inserted to substantially stop the output shaft (241) from rotating. The rotation stopper (30) prohibits the anvil (244B) from rotating by causing the hole (33) to substantially stop the output shaft (241) from rotating.

This aspect may prohibit the anvil (244B) from rotating using a relatively simple configuration.

A determination processing method according to an eighth aspect is designed for use in a tool system (1). The tool system (1) includes: a motor (M1); a fastening unit (24) including a hammer (244A) and an anvil (244B) and configured to fasten a fastening member (X1) by driving a tip tool (socket 242) in rotation; and a control unit (26) for controlling the motor (M1). The determination processing method includes an acquisition step and a condition determination step. The acquisition step includes acquiring a predetermined physical quantity in a state where the hammer (244A) that is rotating with motive power supplied from the motor (M1) is receiving the motive power. The condition determination step includes making determination about wear condition of the fastening unit (24) based on the predetermined physical quantity acquired in the acquisition step with the anvil (244B) prohibited from rotating. The anvil (244B) is arranged forward of the hammer (244A) in a rotational axis direction of the hammer (244A) to receive rotational impact from the hammer (244A).

This aspect allows for providing a determination processing method that contributes to determining the wear condition of the fastening unit (24) more accurately.

A program according to a ninth aspect is designed to cause one or more processors to perform the determination processing method according to the eighth aspect.

This aspect allows for providing a function that contributes to determining the wear condition of the fastening unit (24) more accurately.

Note that the constituent elements according to the second to seventh aspects are not essential constituent elements for the tool system (1) but may be omitted as appropriate.

### REFERENCE SIGNS LIST

1 Tool System
2 Tool
20 Body (Housing)
24 Fastening Unit
241 Output Shaft
242 Socket (Tip Tool)
244A Hammer
244B Anvil
26 Control Unit
27 Detection Unit
3 Rotation Stopper Device
30 Rotation Stopper
33 Hole
M1 Motor
X1 Fastening Member

1. A tool system comprising:
a motor;
a fastening unit including: a hammer caused to rotate with motive power supplied from the motor; and an anvil arranged forward of the hammer in a rotational axis direction of the hammer to receive rotational impact from the hammer, the fastening unit being configured to fasten a fastening member by driving a tip tool in rotation;
a control unit configured to control the motor;
a detection unit configured to detect a predetermined physical quantity in a state where the hammer is receiving the motive power;
a rotation stopper configured to prohibit the anvil from rotating; and
a condition determiner configured to make determination about wear condition of the fastening unit based on the predetermined physical quantity detected by the detection unit in a state where the rotation stopper prohibits the anvil from rotating.

2. The tool system of claim 1, wherein
the predetermined physical quantity is a drive current supplied to the motor.

3. The tool system of claim 2, wherein
the condition determiner is configured to make the determination based on a numerical number of times a local minimum value of the drive current has fallen short of a predetermined value during a prescribed period that begins at a point in time when the rotational impact starts to be applied from the hammer to the anvil.

4. The tool system of claim 2, wherein
the condition determiner is configured to make the determination based on a standard deviation of the drive current during a prescribed period that begins at a point in time when the rotational impact starts to be applied from the hammer to the anvil.

5. The tool system of claim 2, wherein the condition determiner is configured to make the determination based on an average value of the drive current during a prescribed period that begins at a point in time when the rotational impact starts to be applied from the hammer to the anvil.

6. The tool system of claim 1, further comprising a tool, the tool including a housing and designed to be used as a handheld tool, the housing either housing or holding the motor, the fastening unit, the control unit, and the detection unit, wherein
the rotation stopper is configured as a device provided separately from the tool.

7. The tool system of claim 6, wherein
the fastening unit further includes an output shaft arranged forward of the anvil to hold the tip tool thereon,
the rotation stopper has a hole, to which a tip of the output shaft is inserted to substantially stop the output shaft from rotating, and
the rotation stopper is configured to prohibit the anvil from rotating by causing the hole to substantially stop the output shaft from rotating.

8. A determination processing method for use in a tool system, the tool system including: a motor; a fastening unit including a hammer and an anvil and configured to fasten a fastening member by driving a tip tool in rotation; and a control unit configured to control the motor, the determination processing method comprising:
an acquisition step including acquiring a predetermined physical quantity in a state where the hammer that is rotating with motive power supplied from the motor is receiving the motive power; and
a condition determination step including making determination about wear condition of the fastening unit based on the predetermined physical quantity acquired in the acquisition step with the anvil prohibited from rotating, the anvil being arranged forward of the hammer in a rotational axis direction of the hammer to receive rotational impact from the hammer.

9. A non-transitory computer-readable tangible recording medium storing a program designed to cause one or more processors to perform the determination processing method of claim 8.
